(19) United States
(12) Patent Application Publication
(10) Pub. No.: US 2010/0262597 A1
(43) Pub. Date: Oct. 14, 2010

(54) METHOD AND SYSTEM FOR SEARCHING INFORMATION OF COLLECTIVE EMOTION BASED ON COMMENTS ABOUT CONTENTS ON INTERNET

(76) Inventor: Soung-Joo Han, Seoul (KR)

Correspondence Address: Hershkovitz & Associates, LLC, 2845 Duke Street, Alexandria, VA, 22314, US

(21) Appl. No.: 12/679,011

(22) PCT Filed: Dec. 5, 2008
(86) PCT No.: PCT/KR08/07228

§ 371 Date: Mar. 18, 2010

(30) Foreign Application Priority Data
Dec. 24, 2007 (KR) 10-2007-0136565

(51) Int. Cl. G06F 17/30

(52) U.S. Cl. 707/723; 707/803; 707/769; 707/E17.005; 707/E17.014

(57) ABSTRACT

The present invention relates to information search method and system aggressively using comments written by users who have appreciated content. An object of the invention is to display a search result, which is sorted by a proper ranking, in response to a query including an emotional word. For that purpose, while a search database is constructed, firstly emotional words are extracted from the comments and categorized. Next, impressions, or metadata about content are organized from them. Finally the metadata and information about the content are stored. Afterwards, when a user enters a search query including an emotional word, firstly emotional words and non-emotional ones are extracted from the query. Next, content relevant to the non-emotional word is found. Lastly, a ranking result is adjusted according to ‘checked/unchecked’ values (or scores) of an impression item, which matches the emotional word, of the found content.

### TECHNICAL FIELD

The present invention relates to information search method and system using a computer or telecommunications networks. More particularly, it relates to information search method and system that provide a list of content, which is sorted by a proper ranking, corresponding to a search query including an emotional word.

### BACKGROUND ART

When a user enters a search query including an emotional word (e.g., “beautiful sea photo”) into an Internet search engine, current search engines have not been able to provide a high-quality search result, which is sorted by a proper ranking, corresponding to the query. For that reason, the search service administrators have decided the ranking result subjectively, or the search engine has merely provided content with text information (e.g., an image file name) that matches the emotional word included in the query. The above conventional method has been very inefficient in that a few service administrators should manually edit search results from a great amount of content that is increasing quickly on the Internet. In addition, there has been a problem that such search results have low objectivity and reliability because they are decided subjectively by the few service administrators.

In the conventional art, when a search query including an emotional word is issued, the ranking result has been determined usually on the basis of information about documents containing images. In other words, the image file name, an anchor text to link the image file or information/title/text of a web site where the image is stored has been used. However, there has been a problem that the image file name, etc. do not frequently describe the image properly.

On the other hand, there has been a trial that emotional information is extracted from bits to form the content of an image or video itself; a database of the extracted information is used for a search engine. However, this method has been doubtful to search for content relevant to a query representing complicated, delicate and esoteric emotion of human. Besides, the method has been too expensive to be practically used.

Additionally, in the registered Korean Patent Publication No. 10-0462542 titled by “Contents search system for providing confidential contents through network and method thereof,” the number of comments posted by users about content is introduced as a factor to evaluate its reliability. However, in the method, the reliability is evaluated by using only the number of comments regardless of the content of the comments. Accordingly, the method does not refer to the content of the comments and thus has not been able to provide a high-quality result when a user enters a query including an emotional word.

### DISCLOSURE

### Technical Problem

An object of the present invention is to introduce information search method and system that can provide a result using objective and reliable ranking method in response to a query including an emotional word. Moreover, the invention must be applicable in industry. For that purpose, the system collects comments about content on the Internet, constructs a search database using them and utilized it.

### Technical Solution

To solve the technical problem, the invention produces information search method and system based on the following two assumptions.

First, people have similar feelings about the same content. In other words, one's feeling about content is similar to another's feeling about it. For example, when one feels a certain photo is beautiful, another will also feel so. Second, the more users post their comments (annotation, remark, user feedback, reply, review or suchlike) that describe their feelings about content, the more the sum or average of impressions in the comments is approximate to the intensity and the kind of a normal man's feeling about the content. In the present invention, the above assumptions are defined as collective emotion analogous to the concept collective intelligence that states that participation and collaboration of many individuals produce better intellectual results.

On the basis of the above assumptions, the invention aggressively makes use of comments posted by users that appreciated content. The invention constructs a database from the information. Using the database, it provides a method and system for retrieving information matching a query including an emotional word in order to solve the problem. The present invention provides a method for searching information of collective emotion, which comprises the following processes.

First, a main server in the system constructs a search database in which impression score tables are stored (S101), where each row of an impression score table consists of two fields: one is the name of an item in which emotional words are categorized, and the other is its value (See FIG. 7).

Then, the server receives a search query from a user (S102). The server separates and extracts non-emotional word(s) and emotional ones(s) from the transferred query (S103).

Next, the server finds content relevant to the non-emotional words in the search database (S104). In this step, if there is no non-emotional word in the query, step S104 may be omitted.

Next, the server finds out which of impression classes in an impression classification table the extracted emotional word(s) belongs to (S105).

Next, the server determines whether an item, which matches the found impression class in S105, in each impression score table of the content, which has been found in step S104, is checked or a score is assigned in the item (S106).

Next, the server adjusts the ranks of the found content according to a predetermined method dependent on the “checked” values or the scores (S107). The method of adjusting the rank will be explained later in exemplary embodiments.

Finally, the server makes the user's terminal display the adjusted search result (S108).

As described above, information of collective emotion based on comments about content is retrieved.

Hereinafter, each step of the search method will be explained in detail.

Step S101 comprises the following sub-steps.

The server collects documents with comments on the Internet (S201); the server extracts comments from the collected documents (S202). More particularly, the server collects documents with comments by using a web robot that automatically selects and collects fit information from web documents on the Internet, and extracts the comments from the collected documents.

Then, the server searches extracted comments for emotional words (S203). More particularly, the server separates and extracts emotional words (or phrases) from the extracted comments by using processing such as morphological analysis and word stemming.

After that, the server finds out which of impression classes in an impression classification table each of the found emotional words of the content belongs to (S204). Then, the server checks corresponding items in the impression score tables of the content or assigns scores to them (S205).

The impression classification table (See FIG. 3) means a table in which emotional words are classified and itemized. For example, the impression classification table in FIG. 3 shows that the emotional word “angry” belongs to the impression item “pleasant/angry.”

The names of items in the table may be set to a diversity of adjectives (or adverbs). For instance, the names are set into “glad, angry, sorrowful, pleasant, lovely, hateful, desirable, beautiful, ugly, good and nicely.” The classification method is not fixed. On the contrary, it may be changed. Moreover items in the table can be classified either briefly or in detail. For example, “lovely” and “cute” are put into the same category.

As shown before, in step S205, a score may be assigned to an item in the table as well as the item can be checked.

In step S205, scores in the items in the table may be assigned according to the number of emotional comments (or the number of users that posted the comments) and the intensity of feelings. Methods of assigning the scores can be as follows.

First, suppose that there are news content A and B on a web site; users posted 10 comments in which the “good news” responses were written about A, and 3 comments where the “good news” responses were written were posted about B. In this case, a score of the “good” item in the impression score table of A is higher than that of B.

Second, a score of the word “delightful” is higher than that of “glad” because “delightful” means “very glad.” In other words, the more intense an emotional word is, the higher score it gains.

Third, the score may be adjusted by users' recommending (or assenting to) or dissenting from comments. Or, it may be adjusted by intensity of a feeling that is computed according to users' rating content, not text-based comment.

Fourth, when the emotional words are classified, feelings of a kind and the opposite feelings may be categorized into the same item. And then words related to the opposite feelings decrease the score field of the item. For example, “joyful” and “sorrowful” are opposite to each other but distinguished from other feelings. Thus, they can be categorized into an item; emotional words related to “joyful” increase the score of the item. And emotional words related to “sorrowful” decrease the score.

Fifth, when an emotional word represents complex feelings, a score according to the word may be assigned to plural items in an impression score table. As one example, the emotional word “magnificent” means both “grand” and “gorgeous.” Therefore a score of “magnificent” is assigned to two items to which “grand” and “gorgeous” belong.

Sixth, authority, reputation or reliability of a user may influence an impression score of comment that the user posted.

As the next step of S205, the server stores information about the content and the impression score tables, or metadata thereof (see FIG. 7) into the search database (S206). Thereby constructing the database (S101) has been finished.

The above information about content includes index terms, the URL of a webpage containing the content, the URL of the content, ranking number(s) related to the content and so on, as shown in FIG. 6.

The following is illustrating constructing the above-stated database (S101). Suppose that users appreciate a photo titled by “baby photo” in which babies are playing house in a web document; the users post two comments in which “pretty” and “cute” are written. Then the server collects the document and constructs the search database, the server separates and extracts emotional words (or phrases) from the comments about the photograph. The server stores the impression score table of the content, information about it (e.g., URI, URL, condensed information or content itself) and information about documents related to it (e.g., text in the webpage) into the database, where an item named “pretty” in the impression score table is checked.

Additionally, content and words (or phrases) in documents related to them (e.g., web pages) may be indexed or ranked before/after constructing the database. Furthermore, expected phrases to combine emotional words (or phrases) and non-emotional words (or phrases) may be indexed or ranked in advance. Note that comments about content may be considered as a part of the document. The indexing (strictly speaking, inverted indexing) and ranking for the search engine may be processed according to the present invention or other search methods. In addition, objects to be indexed include words (word groups or phrases) in content or documents, but not limited thereto. Thus, comments (including emotional words and non-emotional ones) attached to content or documents may be indexed.

In step S102, the server receives a search query from a user. More particularly, a user sends a search query including an emotional word to the server using the user's terminal.

In step S103, the server separates and extracts emotional word(s) and non-emotional one(s) from the transmitted query. More particularly, the server separates and extracts emotional word(s) and non-emotional one(s) by using processing such as morphological analysis and word stemming. If only an emotional word is in the query, it is self-evident that only the emotional word will be separated and extracted.

In step S104, the server finds content relevant to the extracted non-emotional word(s) in the search database. More particularly, the server finds an index term that matches the non-emotional word(s) in the database and then a list of content to which the index term points is found in the database. FIG. 6 shows that if a separated non-emotional word (or phrase) is “dance music,” web pages A and B where the phrase occurs are found.

In step S105, the server finds out which of impression classes in an impression classification table the emotional word(s) belongs to, where the emotional word has been separated from the search query in step S103. FIG. 3 shows that if the separated emotional word is “boring,” it belongs to the item “interesting/boring” in the table.

In step S106, the server determines whether an item, which matches the found impression class, in each impression score table of the content found in step S104 has been checked. To put it in another way, it looks up an item, in the impression score table, corresponding to the item in the impression classification table, which has been set according to the emotional word(s); it examines the value of the very item of each impression score table of the content, which has been found according to the non-emotional words. Also in the case where a score is assigned to the item, the process is the same as the above-stated that. However, if there is no non-emotional word in the search query, step S104 will be omitted and the server finds all content whose the corresponding items are checked or have scores.

In step S107, the server adjusts the ranks of the found content according to the “checked/unchecked” values of the matched items. In other words, pieces of content that have “checked” values of the matched items in the found content (which is relevant to the non-emotional words) are considered highly relevant to the query, the ranks of them are thus adjusted. Of course, in the case where a score is assigned to the item, the ranks of the above-stated process are adjusted according to the score.

The following are illustrating the rank adjusting methods.

When a user entered the search query “cute baby photo,” firstly the server finds content relevant to the non-emotional word (or phrase) “baby photo.” Then, the server raises the ranks of content whose the “cute” items, in the impression score tables, or metadata thereof, have been checked in the found content.

However, the ranking result may not be adjusted according to the emotional word(s) (or phrase(s)) after the content relevant to the non-emotional word(s) (or phrase(s)) is found. In other words, the result may be adjusted according to the relationship with the content and the non-emotional word (or phrase) after the content relevant to the emotional word(s)(or phrase) is found. Besides, indexes of the emotional words (or phrase) and non-emotional ones (or phrase) may be built in a matrix structure for use.

In addition, intensity of a feeling of an emotional search query may influence a ranking result. For example, when a user enters the search query “gloomy photo,” the search result is sorted simply in descending order of scores of the “gloomy” item. However, provided that a user enters “little gloomy photo” including an adverb which represents intensity of a feeling, content having the “gloomy” score corresponding to “little” may be ranked more highly. The above idea may be implemented as follows. On condition that there is an adverb to express intensity of a feeling in a search query, a score of the adverb is set. For instance, the adverbs “very,” “fairly,” “somewhat,” “rarely,” “scarcely” and “never” are respectively set to 10, 7, 5, 3, 1 and 0. When a result of such a search is generated, pieces of content that have impression scores (approximately) corresponding to the score of the intensity of the feeling are ranked more highly.

For example, suppose that the scores of the “gloomy” items in the impression score tables of web pages A and B are respectively 8 and 10; when a user enters a search query including the emotional words “fairly gloomy,” the adverb “fairly” is set to 7 according to the above instance. Because the score of A is more approximate to the score 7 than that of B, A is ranked higher than B. The above-stated idea may be considered an analog search method.

In addition, when users have different feelings about the same content (particularly, opposite impressions are mixed in comments), such a condition may influence a ranking result. For example, suppose that users posted the ten “interesting” comments about video content A; the ten “interesting” comments and the three “boring” comments about video content B. When the query “interesting videos” is entered, 10 is added to the ranking score of A and 7(=10−3) that of B.

Finally, in step S108, the server makes the user's terminal display the adjusted search result (obtained through the step S107). The displayed result may have a variety of representation. As one example, scores of the impression items about content are clearly visualized to a user. More specifically, a score of each impression item is represented in the form of a bar graph. Additionally, a trend of an impression score about content may be clearly displayed. More specifically, a change of an impression score about content can be displayed in a line chart. In addition, content and the impression score tables, or metadata thereof may be well structured so that they are easily accessed, read and browsed. More specifically, the data can be structured in the form of directories or a matrix so that it is displayed in a user's terminal.

In the case where there are only emotional words in a search query (e.g., “beauty” and “benignity”), step S104 is omitted. Then, any piece of content whose an impression item corresponding to the query is checked may get a high rank.

Besides, apart from the above-stated method that uses database which is previously crawled, indexed and ranked for a search engine, it is possible that content, the related documents and the attached comments are serially scanned on demand and the result sorted by the ranking method is immediately generated.

Hereinafter, a system (See FIG. 9) which searches information of collective emotion based on comments about content will be explained. The system includes web servers 901; a main server for the system 910; a user's terminal 930; a database for an impression classification table 903 and a search database 904.

To be more particular, the main server 910 gets web documents with comments through the telecommunications network 902 from the web servers 901. The device 930 is used to enter a search query including emotional word(s). It is a terminal of a PC, a mobile phone, a PDA (Personal digital assistant) or any other device. It is linked to the main server 910 across the telecommunications network 902. A user gets a search result in response to a query including an emotional word using the terminal 930.

The main server 910 is managed by a search provider. In the present invention, the server stores the database for the impression classification table 903 and the search database 904; it controls and manages steps for searching information of collective information based on comments about content. The search provider sends a search result, which is sorted by a proper ranking, back to the terminal of the user who entered a query including an emotional word, as well as managing the main server 910.

The main server 910 includes the following modules: a document collecting module 911, a comment extracting module 912, an emotional-word finding module 913, an impression-class looking-up module 914, an impression-item checking module 915, a database storing module 916, a data transferring module 917, a content finding module 918, a rank adjusting module 919 and a result handling module 920.

The module 911 collects documents to construct the search database from the web servers 901 by using a web robot or any other method. The module 912 separates and extracts comments from the documents collected by the module 911.

The module 913 finds, separates and extracts emotional word(s) in comments on content or in a search query including emotional word(s). The module 914 looks up an impression class to which the extracted emotional word(s) belong in the database for the impression classification table. The module 915 checks a matched item, in the impression score table, set by the module 914 or assigns a score to the item. The module finds out whether an impression item, which is corresponding to the impression class of the search query, is checked or a score is assigned to the item. The module 916 stores information about the content and the impression score table, or metadata thereof into the search database.

The module 917 receives a search query from the user's terminal 930. The module 918 finds content relevant to the non-emotional word(s) in the search query, in the search database. In the content found by the module 918, if one or more of their impression items corresponding to an impression class set by the module 915 are checked, the checked pieces of content are considered highly relevant to the query. Thus the module 919 adjusts the ranks of the found content. The module 920 makes the user's terminal 930 display the search result adjusted by the module 919.

The main server 910 stores the database 903 (see FIG. 9). An impression classification table (see FIG. 3), where the search provider has classified emotional words and itemized them, is in the database 903. The main server 910 has the database 904 (see FIG. 9) that stores information about content and the impression score tables, or metadata thereof.

### Advantageous Effects

As described above, the information search method and system according to the present invention produce the following effects.

First, a systematic and reliable search result can be obtained because the result is provided through the objective and formulated ranking method based on collective emotion. It is different from the conventional method in which the result is obtained by impressions of a few administrators. Thus, a variety of costs (e.g., labor cost for the administrators) are reduced.

Second, content irrelevant to such a search query is not or scarcely displayed in top rank because collective emotion is reflected, differently from the conventional method in which only relies on text information related to content.

### BRIEF DESCRIPTION OF DRAWINGS

FIG. 1 is a flow chart illustrating process for finding information in response to a search query including an emotional word;

FIG. 2 is a flow chart illustrating process for constructing the search database;

FIG. 3 presents an impression classification table stored in a database;

FIG. 4 is a view illustrating exemplary HTML files to link dance music content uploaded into a web site by a web site manager or a normal user;

FIG. 5 is a view illustrating impressions and reviews, in comment sections, posted by users who have visited the web site and appreciated content linked thereto;

FIG. 6 is a view illustrating an inverted index created by indexing the documents that have been collected;

FIG. 7 is an exemplary view illustrating records comprising the URLs of content and impressions about that which is stored in the search database;

FIG. 8 is an exemplary view illustrating relationship between the records comprising the URLs of content and impressions about that which is stored in the search database AND items in the relevant list of information about documents/content in the inverted index; and

FIG. 9 is a general view illustrating the system for searching information of collective emotion based on comments about content.

### BEST MODE

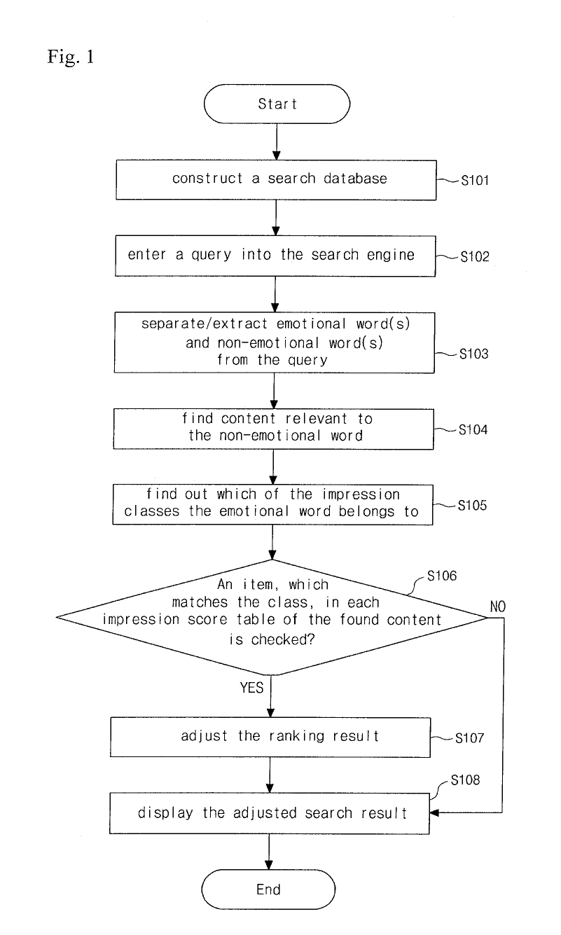

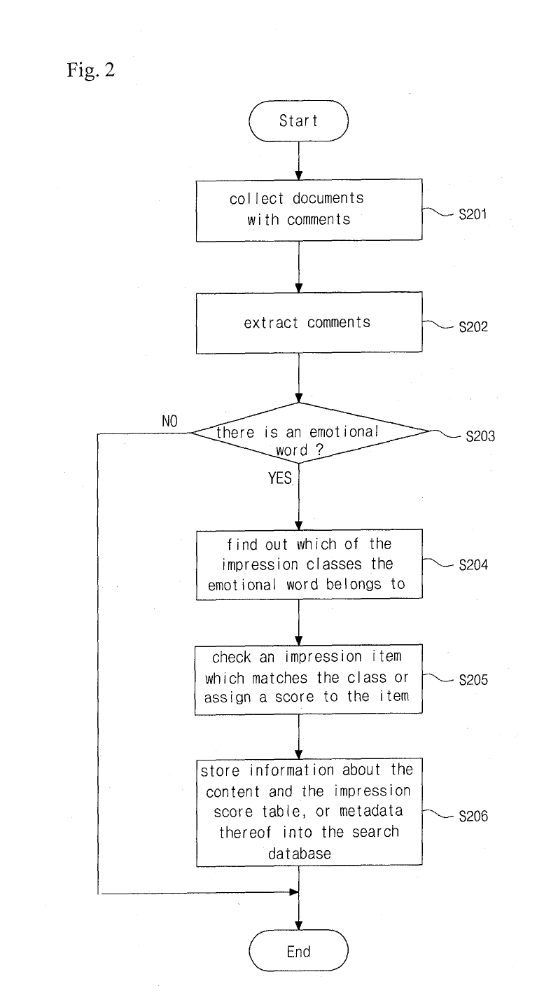

Hereinafter, embodiments of the present invention will be described in detail with reference to the accompanying drawings. In the entire description of the present invention, the same drawing reference numerals are used for the same elements across various figures. According to a first embodiment of the present invention, information responsive to a search query including an emotional word is retrieved, as shown in a flow chart of FIG. 1. According to a second embodiment of the invention, a search database is constructed, as shown in a flow chart of FIG. 2.

First embodiment is as follows.

The embodiment for retrieving information responsive to a search query including an emotional word will be explained in detail with reference to FIG. 1.

The search database should be constructed in advance (S101 in FIG. 1), which will be explained in detail in the second embodiment later.

When a user enters the search query “fun dance music” (S102), the main server receives the query and then separates/extracts the emotional word “fun” and the non-emotional phrase “dance music” (S103).

Next, the server finds a list of information about documents/content relevant to the index term “dance music” in the search database (S104). In the list, an item to indicate webpage A and that to indicate B are stored in the order as shown in FIG. 6.

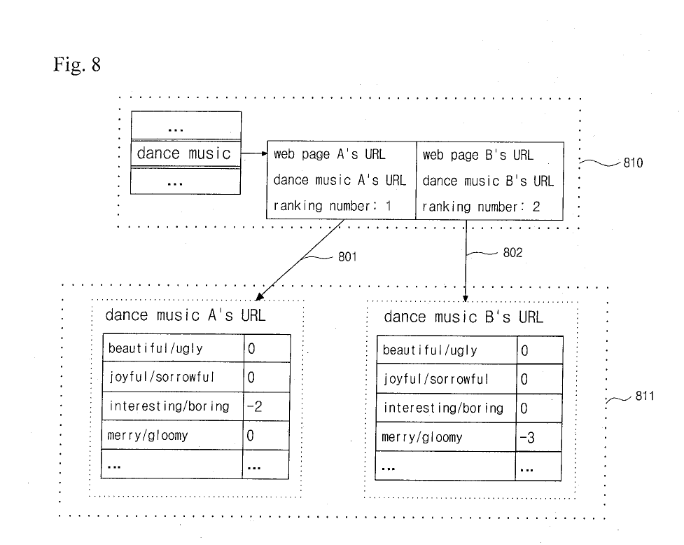

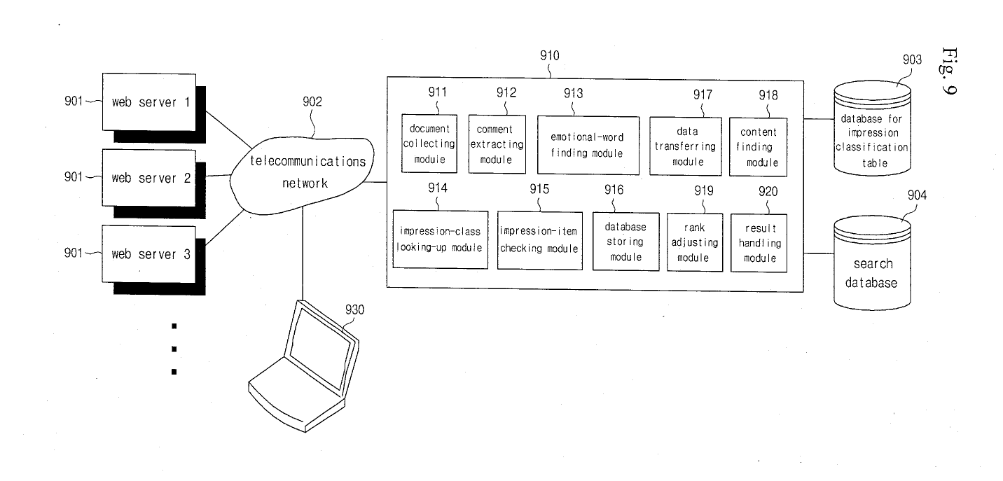

As shown in records 811 in FIG. 8, each record in 811, in the search database, includes an impression score table and content's URL (which is a key field). The server finds such a record (in 801) whose the content's URL field matches the content's URL field of the record related to webpage A/B (see 801 and 802 in FIG. 8).

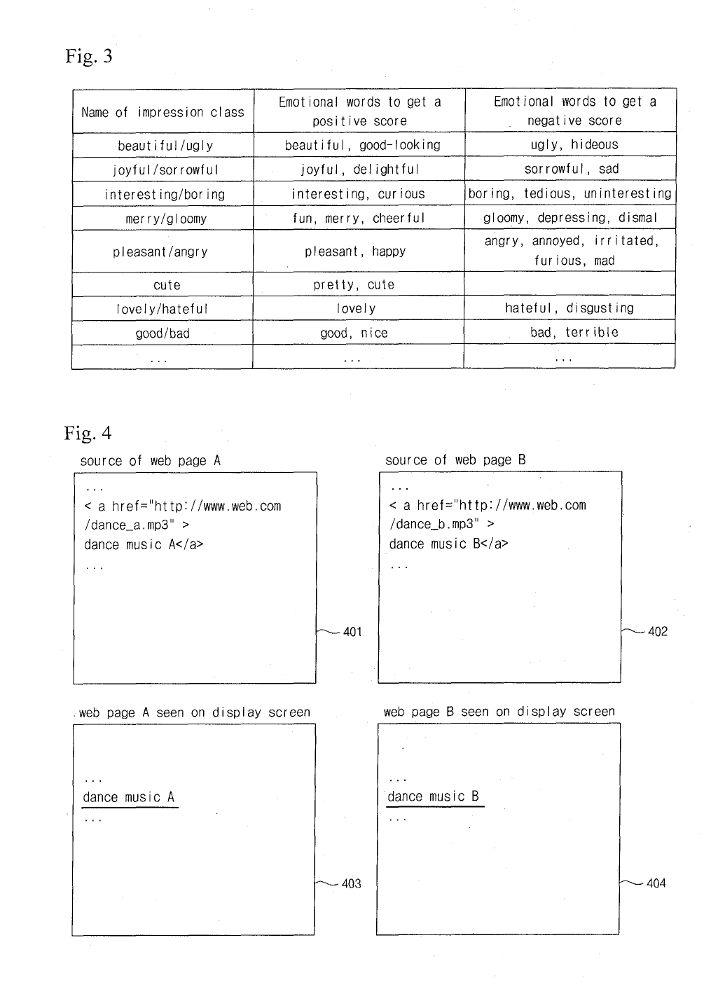

And the server finds out which of impression classes the emotional word “fun” belongs to in the impression classification table (see FIG. 3) (S105). As shown in the table, “fun” belongs to the item “merry/gloomy” and it has a positive score.

Next, the server examines whether a score is assigned to the “merry/gloomy” item of each impression score table of dance music A and B in the search database (S106). The server finds out the numbers 0 and +3 are assigned to “merry/gloomy” item of A and B respectively in FIG. 7.

The server adjusts a ranking number given to each web page on the basis of the scores taken as above (S107). In this case, the end ranking number of webpage A is 1 because 1−0=1 and that of B is −1 because 2−(+3)=−1. As a result, differently from the query “dance music,” the response to the query “fun dance music” reflects collective emotion. Thus, webpage B is ranked higher than A.

When a searcher enters the query “boring dance music,” in the same way, the server finds out the numbers −2 and 0 are assigned to the “interesting/boring” item of dance music A and B, respectively. On condition that the extracted emotional word(s) is negative, the server reverses the sign of an impression score of the emotional word before subtracting each impression score from a ranking number. In this case, the end ranking number of webpage A is −1 because 1−(−(−2))=−1 and that of B is 2 because 2−0=2. Thus, webpage A is ranked higher than B; the server makes the user's terminal display the search result (S108).

Second embodiment is as follows.

The embodiment for constructing the search database will be explained in detail with reference to FIG. 2.

A search provider previously creates a database for an impression classification table in which a variety of emotional words are classified as shown in FIG. 3. For example, “interesting” and “boring” are opposite to each other but distinguished from other feelings.

Thus, one impression class item called “interesting/boring” is set. In addition, the words “tedious” and “boring” are classified into the impression class “interesting/boring.” Accordingly, when the word “tedious” is included in the comment, a negative score is assigned to an item of the impression class “interesting/boring.” In addition, the words “fun,” “merry” and “cheerful” belong to the impression class “merry/gloomy” and a positive score is assigned to an item of the class.

An administrator of a website or a normal user uploads two HTML files to link dance music content on the website as shown in FIG. 4. Content 401 and 402 are the sources of the two. The anchor text in content 401 contains “dance music A” and 402 “dance music B” to describe the content. Each of the two links refers to related content. The two are displayed, like web pages 403 and 404, to human users.

Users visit the web site and appreciate the dance music linked to the web pages.

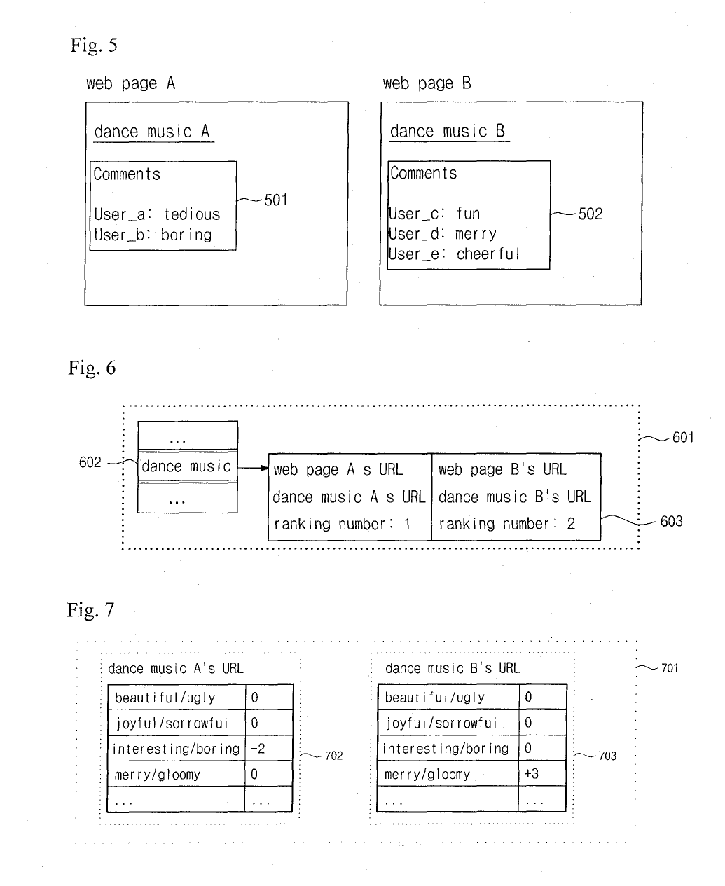

Then, the users post their impressions and opinions into the comment sections (FIG. 5). The impressions for dance music A were not good and two users wrote negative comments (501). On the contrary, the impressions for dance music B were good and three users wrote positive comments (502).

At this time, the server collects the web pages with the comments as shown in FIG. 5 (S201 in FIG. 2). The collected documents may be indexed and ranked.

When constructing the inverted index 601 in FIG. 6, the server stores the index term “dance music” with the URLs of the web pages related thereto, the URLs of relevant content, etc into the search database 904. Additionally, ranking numbers are stored along with them. The rankings numbers may be computed according to the present invention, or may be done by other algorithms irrespective of the invention.

In the embodiment, regardless of an emotional word, webpage A got the ranking number 1 and B the number 2 (the lower the ranking number is, the higher the rank is). Merely if the search query “dance music” is issued, webpage A is ranked higher than B in its response.

The server analyzes impressions in the comments about dance music A and B; it classifies them. The result is stored in the search database. Each of the stored records includes content's URL field and items of impression scores of the content (701 in FIG. 7), where the content's URL field is the key of the record. Usually, a unique identification number is used as a document/content identifier. However, in the embodiment, content's URL is used as the identifier.

For that purpose, the server extracts comments from the collected documents (S202) and finds emotional words in the extracted comments through the word stemming, etc (S203). Then, the server finds out which of the items in the impression classification table each of the emotional words belongs to (S204). Then, the server assigns scores to items, in the impression score tables, corresponding to the emotional words (S205).

More particularly, the server extracts two emotional words “boring” and “tedious” from the comments about dance music A. As shown in the impression classification table of FIG. 3, the two words belong to the impression item “interesting/boring.” The server assigns a negative score, which the two words get, to the item. Thus, the score −2 is assigned to the item “interesting/boring” of the corresponding record (702 in FIG. 7).

On the other hand, the server extracts the three emotional words “fun,” “merry” and “cheerful” from the comments about dance music B. As shown in the impression classification table, the three words belong to the impression item “merry/gloomy.” The server assigns a positive score, which the words get, to the item. Thus, the score +3 is assigned to the item “merry/gloomy” of the corresponding record (703 in FIG. 7).

As described above, the server constructs the search database which stores the information about the content and the impression score tables thereof (S206).

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

1-8. (canceled)

9. A method for searching information of collective emotion based on comments about content, comprising:
constructing a search database in which impression score tables are stored (S101);
receiving a search query from a user (S102);
separating and extracting emotional word(s) and non-emotional one(s) from the transferred query (S103);
finding content relevant to the extracted non-emotional word(s) in the search database (S104);
finding out which of impression classes in an impression classification table the extracted emotional word(s) belongs to (S105);
determining whether an item, which matches the class, in each impression score table of the content is checked or a score is assigned to the item (S106);
adjusting a ranking result according to a predetermined method dependent on the “checked” values or the scores of the items (S107); and
making the user's terminal display the adjusted search results (S108).

10. The method of claim 9, wherein the constructing (S101) comprising:
collecting documents to which comments are attached (S201);
extracting comments from the collected documents (S202);
searching the extracted comments for emotional words (S203);
finding out which of impression classes in the impression classification table each of the found emotional words of the content belongs to (S204);
checking corresponding items in the impression score tables or assigning scores to them (S205); and
storing information about the content and the corresponding impression score table into the search database (S206).

11. A system for searching information of collective emotion based on comments about content, comprising a main server, where the main server comprises:
a database, for an impression classification table, to store an impression classification table in which names of impression classes and emotional words corresponding thereto have been classified;
a search database to store information about content and the impression score tables thereof;
a document collecting module to collect documents which are necessary to construct the search database;
a comment extracting module to separate and extract comments from the collected documents;
an emotional-word finding module to separate and extract emotional word(s) from comments about content or a search query including emotional word(s);
an impression-class looking-up module to find out which of impression classes in an impression classification table the extracted emotional word(s) belongs to;
an impression-item checking module to check an item, which matches the emotional word(s), in each impression score table of content or assign a score to the item, and to examine whether an item, which matches the class, in each impression score table of content is checked or a score is assigned to the item;
a database storing module to store information about content and the impression score tables thereof into the search database;
a data transferring module to receive a search query from a user that entered it into a terminal of a client;
a content finding module to find content relevant to non-emotional word(s) included in the search query m the search database;
a rank adjusting module to adjust a ranking result according to the checked/unchecked” value or the score of the matched item in each impression score table of the found content; and
a result handling module to make the user's terminal display the adjusted search results.

12. The method of claim 10, wherein the checked value or the assigned score is dependent on other users' recommending or dissenting from the comments or users' rating content, not text-based comments.

13. The method of claim 10, wherein the checked value or the assigned score is dependent on the number of class-specific emotional words the number of comments having class-specific emotional words or the number of users who posted comments containing class-specific emotional words, in the comments.

14. The method of claim 10, wherein authority, reputation or reliability of a user who posted the comment influences the checking or the assigning.
